(19) United States
(12) Patent Application Publication
(10) Pub. No.: US 2017/0154162 A1
(43) Pub. Date: Jun. 1, 2017

(54) SYSTEMS AND METHODS FOR MANAGING ADVERSE REACTIONS IN CONTRAST MEDIA-BASED MEDICAL PROCEDURES

(71) Applicant: BAYER HEALTHCARE LLC, WHIPPANY, NJ (US)

(72) Inventors: Sridhar BALASUBRAMANIAN, MONROEVILLE, PA (US); Srikanth MRUTHIK, GIBSONIA, PA (US)

(73) Assignee: Bayer HealthCare LLC, Whippany, NJ (US)

(21) Appl. No.: 15/320,791

(22) PCT Filed: Jul. 9, 2014
(86) PCT No.: PCT/US14/45847

§ 371 Date: Dec. 21, 2016

(51) Int. Cl. G06F 19/00

(52) U.S. Cl. CPC G06F 19/3431; G06F 19/321

(57) ABSTRACT

Described is a method of managing adverse reactions that may occur during a medical procedure that involves the administration of contrast media. The method includes acquiring, by a data acquisition unit, information about a patient and an upcoming medical procedure that involves the administration of contrast media, computing in advance of the medical procedure, by a risk assessment unit, a prediction of a risk that the patient will experience an adverse reaction to the contrast media based on the information about the patient and the upcoming medical procedure, and presenting to one or more medical personnel in advance of the medical procedure, by a risk alert unit, an indication of the risk in a visually perceptible form. Also described are systems and software that implement methods of managing adverse reactions.

### BACKGROUND OF THE INVENTION

Field of the Invention

This disclosure relates to systems and methods for managing adverse reactions, and particularly for predicting whether a patient will suffer an adverse reaction as a result of a medical procedure.

Description of Related Art

The following information is provided to assist the reader to understand the invention disclosed below and the environment in which it will typically be used. The terms used herein are not intended to be limited to any particular narrow interpretation unless clearly stated otherwise in this document. References set forth herein may facilitate understanding of the present invention or the background of the present invention. The disclosure of all references cited herein are incorporated by reference.

Medical imaging procedures often rely on the use of contrast media that is injected into the biological structure to be imaged such that the medical imaging procedure provides more detailed information to a radiologist or other medical personnel responsible for analyzing the medical imagery. Contrast media is often injected into a patient's vasculature prior to the medical imaging procedure and the patient's renal system is thereafter tasked with clearing the contrast media from the patient's bloodstream. The administration of contrast medium is generally completed with an injector, which may be a powered injector or hand injector.

According to conventional radiographic diagnostic imaging techniques such as X-ray procedures, X-rays pass through a target object and expose an underlying photographic film. The developed film then provides an image of the radio-density pattern of the object. Less radio-dense areas produce a greater blackening of the film; more radio-dense, bony tissues produce a lighter image. Effective contrast media for X-ray may be either less radio-dense than body tissues or more radio-dense. The less radio-dense agents include air and other gases; an example of a more radio-dense contrast material is a barium sulfate suspension or iodinated injectable media.

Computed tomography (CT) is superior to conventional radiography in its ability to image, with extremely high resolution, a succession of thin sections of an object at specific points, lines, or planes along the X, Y, or Z axis of the target object. However, because this procedure is also based on the detection of differences in radio-density, requirements for contrast media in CT are essentially identical with those for conventional radiography.

Magnetic resonance imaging (MRI) systems for body imaging operate on a different physical principle. Generally, MRI relies on the atomic properties (nuclear resonance) of protons in tissues when they are scanned with radio frequency radiation. The protons in the tissue, which resonate at slightly different frequencies, produce a signal that a computer uses to tell one tissue from another. MRI provides detailed three-dimensional soft tissue images.

Fluoroscopy imaging systems may provide real-time X-ray images of internal structures based on differences in the radio-density of the imaged object components. As in X-ray procedures, fluoroscopy may be enhanced by the use of more radio-dense contrast media that may be injected into the object being imaged. For instance, in angiography procedures, radio-dense contrast media may be injected into the cardiac vasculature in order to trace the path of blood through the vasculature and determine, for instance, the location of blockages in the cardiac vasculature.

Contrast media used in imaging procedures, such as those discussed above, is generally safe for healthy patients. However, some patients still experience adverse reactions in response to contrast media injections. These side effects range from minor physiological disturbances to, in some rare instances, life threatening situations. Reactions suffered by patients in response to contrast media have been the subject of much study over the last few decades. For example, the ACR Manual on Contrast Media (Version 9, 2013), published by the American College of Radiology, provides a general overview of the recognized adverse events that can occur in a patient following delivery of contrast media. By way of further example, Cochran and coworkers reviewed data on adverse events over a nearly 15 year period and reported on the severity of these reactions and certain trends within this data set. See S. T. Cochran, et al., “Trends in Adverse Events After IV Administration of Contrast Media,” Am. J. of Roentgenology, (2001) 176:1385-1388. Some studies have even focused on providing the necessary background to predict occurrences of adverse reactions for a given patient and set of circumstances. See R. Mehran, E. D. Aymong, E. Nikolsky, et al., “A simple risk score for prediction of contrast-induced nephropathy after percutaneous coronary intervention,” J Am Coll Cardiol. 2004, 44(7): p. 1393-1399.

However, despite the abundance of imaging procedures that involve the administration of contrast-media that occur each day in a typical hospital facility, or perhaps because of it, useful information about adverse reactions suffered by patients is not effectively collected or is altogether lost. For example, even in this information age, it is still standard practice at many facilities to use paper charts and standardized medical records to note the occurrence of an adverse reaction in a patient. Moreover, despite the abundance of information that is known about a patient and the procedure being performed on the patient, there is still no effective system or method to predict the occurrence of an adverse reaction in a patient in advance of the procedure and alert the relevant personnel of this risk in a way that can allow the adverse reaction to be altogether prevented. Typically, the contra-indication data for a patient involving contrast imaging is “found” right around the start of the procedure, which is even after the patient enters the scan room. Such a delay costs the hospital staff time, and prevents clinicians from making pro-active decisions in advance of the procedure that would ultimately save both time and money.

### SUMMARY OF THE INVENTION

In one aspect, the present invention provides a method that includes acquiring information about a patient and an upcoming medical procedure for the patient that involves the administration of contrast media to the patient. The method also includes computing, based on the information about the patient and the upcoming medical procedure, a risk that the patient will experience an adverse reaction to the contrast media. The computation is done in advance of the medical imaging procedure. The method also includes presenting to one or more medical personnel an indication of the risk in a visually perceptible form. The indication is also made in advance of the medical procedure.

In some non-limiting embodiments, the information about the patient includes one or more of a patient's age, sex, underlying medical conditions, hematologic conditions, medications, and history of adverse reactions to contrast media. Further, the patient information may be acquired from a hospital system selected from a radiology information system, an electronic medical record system, and a laboratory information system.

In certain non-limiting embodiments, the risk is predicted by comparing the information about the patient and the medical procedure to one or more risk factors stored in memory.

In some non-limiting embodiments, the indication of risk can be displayed on an interface associated with a contrast media injector.

In certain non-limiting embodiments, the method may additionally include preparing a database record that includes information about the patient, information about the procedure, and the computed risk. The database record may be stored in a database.

In certain non-limiting embodiments, the method also includes acquiring outcome information regarding whether an adverse reaction to the contrast media occurred in the patient as a result of the medical procedure. A database record that includes information about the patient, the procedure, the computed risk, and the outcome information may be created and stored in a database.

In another aspect, the invention involves a system for adverse reaction management. The system includes a data acquisition unit programmed to acquire information about a patient and information about an upcoming medical procedure for the patient. The system further includes a risk assessment unit programmed to compute a risk of an adverse reaction in the patient based on the information about the patient and the information about the upcoming medical procedure acquired by the data acquisition unit. The system also includes a risk alert unit programmed to present an indication of the risk in a visually perceptible form in advance of the medical procedure.

In some non-limiting embodiments, the data acquisition unit is in electronic communication with a hospital system selected from a radiology information system, an electronic medical record system, and a laboratory information system.

In some non-limiting embodiments, the indication of the risk is presented on an interface of an injector.

In certain non-limiting embodiments, the system can also include at least one database to store information about the patient and the upcoming medical procedure.

The system can also include an outcome recording unit programmed to collect and process outcome information about an outcome of the medical procedure. The system may also include at least one database to store the outcome information.

Further details and advantages will become clear upon reading the following detailed description in conjunction with the accompanying drawing figures.

### BRIEF DESCRIPTION OF THE DRAWINGS

FIG. 1 is a flowchart illustrating the steps of an exemplary process of managing information about adverse reactions according to one embodiment of the invention.

FIG. 2 is a schematic view of an adverse reaction management system according to one embodiment of the invention.

FIG. 3 is a partial schematic view of the system according to FIG. 2, depicting in more detail portions of the system involved in the information acquisition stage.

FIG. 4 is a partial schematic view of the system according to FIG. 2, depicting in more detail portions of the system involved in assessing a patient's risk of experiencing an adverse reaction.

FIG. 5 is a partial schematic view of the system according to FIG. 2, depicting in more detail portions of the system involved in alerting personnel of a patient's risk of experiencing an adverse reaction.

FIG. 6 is a partial schematic view of the system according to FIG. 2, depicting in more detail portions of the system involved in outputting and storing data about adverse reactions.

### DESCRIPTION OF THE PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and configurations. It is also to be understood that the specific devices, features, and components illustrated in the accompanying drawing figures and described herein are simply exemplary and should not be considered as limiting. As used herein and in the appended claims, the singular forms “a,” “an,” and “the” include plural references unless the content clearly dictates otherwise.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from one unit and transmits processed data to the second unit. For instance, data communicated from one component to another can pass through one or more nodes, which can serve as a local data collection and communication module performing functionality commonly associated with a networked system, such as “store and forward” and other low-level data collection, processing and communication functions. It will be appreciated that numerous other arrangements are possible. Throughout this description and in the figures, communication links from one component to another will be discussed and illustrated. For clarity, the arrows indicate the direction of the communication. The arrows may be understood to indicate either separate, one-way communication links. Alternatively, they may indicate a single communication link that facilitates two-way communication. As would be appreciated by those skilled in the art, the communication link(s) may be a telephone line, a wireless communication link, or the Internet, among others.

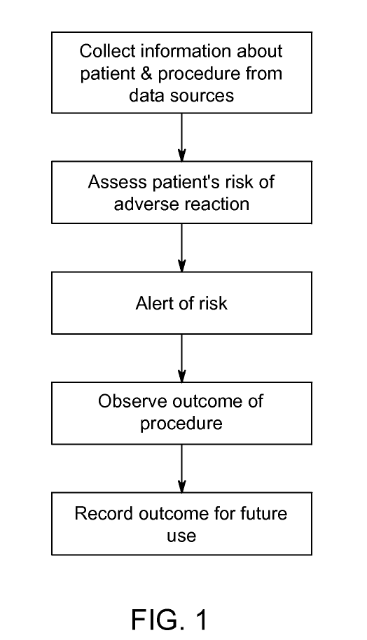

FIG. 1 is a flowchart illustrating various steps, stages, or phases of an exemplary process of managing adverse reactions in a patient, which includes collecting information related to the patient and an upcoming medical procedure, using the collected information to assess the patient's risk of experiencing an adverse reaction during the procedure, alerting the appropriate personnel of the risk, and observing and recording information about any adverse reactions the patient experienced during the procedure. The flowchart is provided to facilitate understanding of the various embodiments of the invention that will now be disclosed. The various systems and methods described hereinafter is generally applicable to the generic process outlined in FIG. 1.

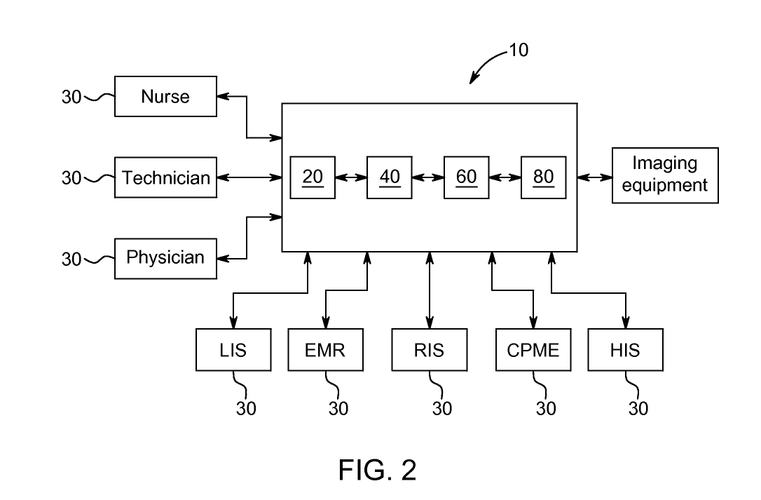

FIG. 2 illustrates a system 10 for adverse reaction management according to one embodiment. System 10 can include a data acquisition unit 20 for gathering information about a patient and a scheduled or proposed medical procedure involving the patient from a variety of information sources 30. System 10 can also include a risk assessment unit 40 which uses the information acquired by data acquisition unit 20 to compute a patient's risk of experiencing an adverse reaction as a result of the scheduled or proposed medical procedure. System 10 may also include a risk alert unit 60 that alerts relevant personnel about the risks associated with a particular procedure. System 10 may also include an outcome recording unit 80 that collects and stores information about any adverse reactions the patient experienced during the procedure for future consideration. Each unit can have associated therewith a set of programming instructions, such as in the form of software stored in memory, designed to perform some desired task or action, as well as a processor to execute the stored instructions.

In some non-limiting embodiments, system 10 may include a single computer, a server computer, a combination of computers, or any other combination of hardware and/or software components. The individual units or components of system 10 may be localized or, in some embodiments, distributed among any number of hardware devices, local or remote, preferably in communication with one another. Further, each unit may itself be comprised of a distributed system, such as a series of servers and/or computers. In addition to the hardware associated therewith, system 10 includes software residing on various hardware components that include a set of programming instructions that can be executed by a processor, or series of processors, to perform the tasks described herein. System 10 may be configured as a stand-alone system (e.g., a single computer including the associated software), as a location-wide (such as hospital-wide) system (e.g., a series of computers and software networked together within a single location), or as an enterprise system (e.g., a series of computers and software networked together across an entire organization), among other configurations. In one non-limiting example, certain components of system 10, or even the entire system 10, may be incorporated into the software and hardware associated with medical imaging equipment (e.g., scanner and injector), such as the Certegra® @ Point of Care product offered by Bayer Healthcare LLC. For example, the hardware and software associated with an injector device may include data acquisition unit 20, risk assessment unit 40, risk alert unit 60, and/or outcome recording unit 80, or aspects thereof. In another example, certain components of system 10, or even the entire system 10, may be provided as part of an enterprise platform that performs other functions as well, such as the Radimetrics™ Enterprise Platform offered by Bayer Healthcare LLC. It will be appreciated that various other arrangements are possible. System 10 may also have one or more databases associated therewith. Particularly, the data acquisition unit 20 and outcome recording unit 80 may be in communication with one or more databases associated therewith.

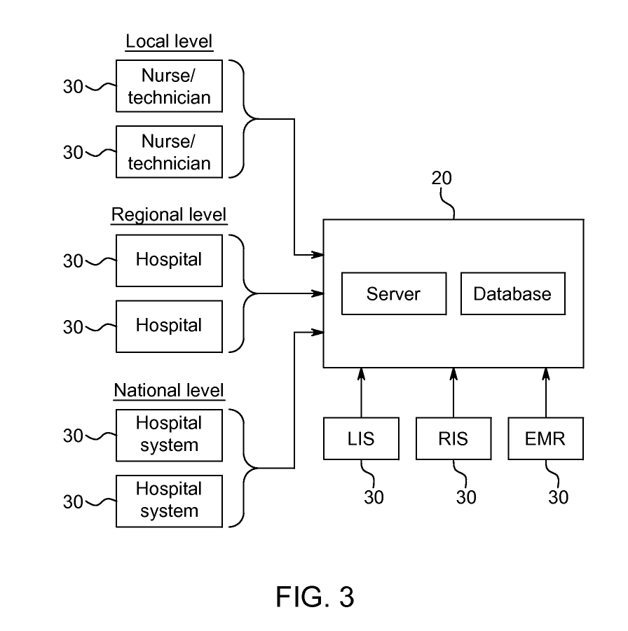

FIG. 3 provides a more detailed illustration of the operation of data acquisition unit 20 and the interaction between the data acquisition unit 20, or more particularly a computer or other hardware component on which data acquisition unit 20 resides, and information sources 30. While the type of information gathered by data acquisition unit 20 is not necessarily limited, the information should generally include information about the characteristics of the patient, such as a patient's age, sex, etc., and information about the upcoming medical procedure, such as information about the type of contrast, delivery method, delivery rate, total dosage, etc. In the context of a system for predicting and managing contrast-induced adverse reactions in a patient, patient characteristic information should include the information about a patient that is reasonably needed to assess and predict the risk of the patient experiencing an adverse reaction in response to the administration of contrast media. Whether a patient is at risk of suffering an adverse reaction generally turns on an assessment of certain risk factors, and the information that may be collected by data acquisition unit 20 can include that needed to assess these risk factors in the patient. The risk factors associated with different medical procedures are generally well-known and commonly reported in the scientific literature. With respect to the administration of contrast media to a patient, one generally accepted source of information about the associated risk factors is the ACR Manual on Contrast Media, (Version 9; 2013) (cited above), which is expressly incorporated herein by reference. Exemplary risk factors associated with contrast media delivery include: patient's age, patient's sex, patient's underlying medical conditions, patient's hematologic conditions, patient's medications, patient's history of adverse reactions, and details about the contrast media delivery method itself, such as total dosage, delivery rate, etc.

Patient characteristic information can be obtained by data acquisition unit 20 from a variety of sources. For example, basic demographic information, such as patient age and sex, may already be known and reside within the files of the medical facility, such as within a hospital information system (HIS), radiology information system (RIS), electronic medical record (EMR) system, or similar system, and these systems could thus serve as information sources 30 from which information is acquired by data acquisition unit 20. Additional information about the patient, such as whether the patient has a history of experiencing adverse reactions, whether the patient suffers from an underlying medical condition that may increase the risk of an adverse reaction, such as asthma, heart disease, dehydration, renal disease, or diabetes, or whether the patient is taking any medications known to react with contrast media, may also be known and available. For example, this information may have been entered into the patient's electronic file during a previous visit to the facility, it may have been transferred from another facility in anticipation of the patient's visit, or it may be gathered directly from the patient during intake, e.g., when the patient arrives at the facility, by asking the patient a series of questions.

Patient information can also be gathered by radiologists, physicians, technicians, nurses, and other personnel that interact with the patient. In some embodiments, information can be gathered by those responsible for operating the medical equipment used to deliver the contrast media (e.g., contrast media injectors), such as through the use of handheld tablet computers or by entering information directly into an interface associated with the injector or other medical equipment, including through an app programmed into memory of the tablet computer or injector interface that is specially designed to communicate with data acquisition unit 20 and aid in the collection of the requisite information.

Patient information may also be gathered by other departments within the medical facility. For example, a patient that arrives at a medical facility for a medical imaging procedure may first undergo laboratory work to test for hematologic conditions, with the results of the lab work being stored in a laboratory information system (LIS). The information in the LIS may be extracted and transferred to data acquisition unit 20. Information about the patient can also be acquired from other facilities or even other medical systems. For example, the aforementioned laboratory work may have been performed offsite at another facility, and the results thereof could then be transferred to data acquisition unit 20. Patient information may even be shared on a regional or national level between different medical facilities by utilizing a one or more shared databases of patient information, including one or more databases associated with systems 10 operating at other facilities.

Information about the medical procedure can also be obtained from information sources 30 in a similar manner. In the case of a medical procedure that involves the administration of contrast media, for example, information about the type of contrast media that will be administered, the rate of delivery, the overall dose, etc. may be obtained from the RIS work list or a computerized physician order entry (CPOE) system. Information about the delivery rate and overall dose could also be obtained directly from the injector once the injector is programmed with the injection protocol, or could be manually inputted by the ordering physician or technician.

With respect to each of the above-described information sources 30, data acquisition unit 20 can be in electronic communication with these sources, directly or through one or more intermediary components, to acquire the information needed for system 10 to operate effectively. For example, data acquisition unit 20 may be in electronic communication with the RIS, HIS, EMR system, LIS, injectors, and/or handheld computers. Alternatively, information can be entered directly into data acquisition unit 20. Relevant information can be transferred to data acquisition unit 20 using standard, commonly used data transfer protocols, such as CCD, CCR, HL7, or HL7 CDA. HL7 is one of the most widely used standards that enables medical data to be shared between applications. CCD is Continuity of Care Document, a fast evolving standard that is being widely accepted and implemented by medical institutions. Information may be acquired by data acquisition unit 20 in real time or near real time (i.e., shortly after it is collected), though certain information may be transmitted to data acquisition unit 20 a significant amount of time after it is collected. A patient ID number or other unique identifier can be used to locate and classify patient and/or procedure information.

Transfer of this information to data acquisition unit 20 can be accomplished automatically, including by pushing information to data acquisition unit 20 once known. For example, when a patient is received in intake in advance of the medical procedure or when the patient's pre-procedure lab work is complete, the information could be automatically sent to data acquisition unit 20 or to another location which is accessible to data acquisition unit 20. Data acquisition unit 20 may also be programmed to actively seek out this information, such as when a query is made as to whether a particular patient is at risk of an adverse reaction, or upon receiving notice of an upcoming procedure for a particular patient. For example, data acquisition unit 20 may be programmed to access one or more databases associated with HIS, RIS, EMR, or LIS and extract the needed information corresponding to a particular patient ID or other unique identifier. If data acquisition unit 20 is unable to locate key information, it can prompt a person to manually enter the information or to request that such information be gathered. One of the primary goals of data acquisition unit 20 is to ensure that system 10 has the necessary information about the patient and the medical procedure to properly assess the risk that the patient will experience an adverse reaction as a result of the procedure. In this regard, data acquisition unit 20 can be programmed to have a checklist of “required” or “desired” information, and then actively seek out this information from potential information sources 30 using common data extraction techniques and communication protocols. Data acquisition unit 20 can then compare the known information with the desired information and alert the appropriate person(s) in the event additional information is needed. Ideally, data acquisition unit 20 has one or more databases associated therewith which can store the acquired information.

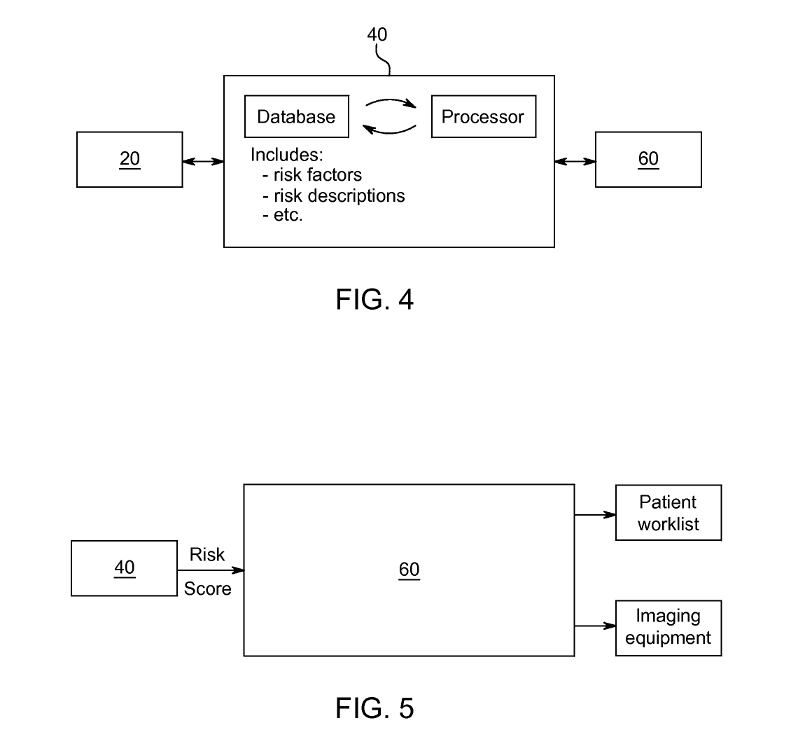

With reference to FIG. 4, system 10 further includes a risk assessment unit 40 in communication with data acquisition unit 20 which utilizes information collected by data acquisition unit 20 to compute a patient's risk of experiencing an adverse reaction in response to a particular medical procedure, as well as the severity of any such potential reaction. Assessment can be done automatically once the information is collected, or it can be done at a later time, such as upon request of a user.

A variety of techniques can be employed to assess the risk and severity of an adverse reaction. One such technique involves using the available data to analyze certain known risk factors to arrive at an overall risk assessment for a particular procedure and patient. The risk assessment unit 40 can have memory programmed with different risk factors and risk descriptions. Risk assessment unit 40 can further be programmed with a set of rules which may be in the form of a rules table and/or equations or algorithms which apply the information from data acquisition unit 20 to the risk factors to compute an overall risk assessment, as well as the severity of the potential reaction, in a patient.

For instance, risk assessment unit 40 may consider a series of known risk factors. Based on the information about the patient and the procedure, risk assessment unit 40 can then assign a value to each of these risk factors, and these values can be totaled across all risk factors to determine a patient's overall risk score. The patient's overall risk score can then be compared to a pre-defined risk scale which associates a risk score with a risk assessment, such as through a lookup table, to arrive at the patient's overall risk assessment. The overall risk assessment may be a specific, quantitative assessment of the risk (e.g., the patient has a 35% chance of experiencing an adverse reaction) or a more general, subjective assessment (e.g., the patient is at a high risk of experiencing an adverse reaction). Similarly, the severity of the potential reaction, such as “mild” or “severe” can also be computed using the information about the patient and procedure.

By way of example, the scientific literature has reported on a number of risk factors associated with contrast media administration, and the results of these studies and the risk factors identified therein can be used in configuring risk assessment unit 40 in accordance with this invention. Exemplary risk factors are discussed and reported in the ACR Manual on Contrast Media, (Volume 9; 2013) which is incorporated herein by reference. These risk factors include, but are not necessarily limited to: age (such as over 50), sex, underlying medical conditions (such as diabetes, anemia, or use of an intra-aortic balloon pump), hematologic conditions, medications, contrast administration details (e.g., fast injection; large dose [e.g., over 65 g]; interarterial; high [e.g., over 70%] contrast agent concentration), systolic blood pressure (such as less than 80 mm Hg), and past adverse reactions to the specific contrast agent being used or contrast agents in general. Within each of these risk factors, a scoring system can be developed that is then used to determine a value associated with that particular risk factor for the particular patient. For example, the “age” risk factor could have a scoring system in which a value of 0 is assigned if the patient is under 55, a value of 2 is assigned if the patient is between 55 and 75, and a value of 4 is assigned if the patient is older than 75. Similarly, the scoring system for the “underlying medical condition” risk factor could assign a value of 3 if the patient has diabetes and a value of 5 (which could be cumulative with values assigned due to other conditions) if the patient has systolic blood pressure of less than 80 mm Hg. The appropriate values to assign within each risk factor can be readily determined by one of skill in the art from a review of the available scientific literature. The risk factors could also be specific to a particular type of adverse reaction, such as contrast induced nephropathy, extravasation, or anaphylactic reactions, and thus the overall risk assessment could also be specific to a particular type of reaction.

Risk assessment unit 40 can include a set of rules that determine which risk factors to consider, what information gathered by data acquisition unit 20 is to be applied to the risk factors, and how to apply this information to the risk factors to determine a patient's overall risk assessment, which would serve as an indication of the patient's risk of experiencing an adverse reaction. As mentioned above, the scientific literature has identified a number of risk factors that should be considered in assessing the risk of a contrast-induced adverse reaction. The risk factors identified in this literature can be addressed by risk assessment unit 40 through a set of programming instructions. For example, risk assessment unit 40 may be programmed to parse data acquired by data acquisition unit 20 to find the age of the patient, compare that age to the predefined scale associated with the “age” risk factor, and, depending on where within that scale the patient's age falls, assign the risk value associated with the patient's age (e.g., a value of 4 if the patient is over 75). By way of another example, risk assessment unit 40 could review information identifying underlying medical conditions of the patient and cross-check those medical conditions with a list of conditions that give rise to an increased risk of an adverse reaction. If the patient is suffering from a condition that gives rise to an increased risk of an adverse reaction, risk assessment unit 40 can then assign the risk value associated with that particular condition (e.g., a value of 4 for diabetes). By way of yet another example, risk assessment unit 40 could determine the expected volume of contrast media being delivered for the scheduled or proposed medical procedure and assign a risk value associated with that volume, with a higher volume of contrast media giving rise to a greater risk value. Risk assessment unit 40 could repeat this process for each of the risk factors. If the information necessary to value a particular risk factor is not known, risk assessment unit 40 could query data acquisition unit 20 to locate this information and/or prompt an operator to supply this information.

Risk assessment unit 40 can then total the values for each of the risk factors to arrive at an overall risk score for the patient. This overall score can be compared to a predetermined scale, which may also be based on the reported results of clinical studies, to assess the patient's risk of experiencing an adverse reaction. For example, if the overall risk score is 5 or less, the patient may be said to have a low risk of an adverse reaction for the particular procedure, while if the overall risk score is greater than 16, the patient may be said to have a high risk of an adverse reaction.

By way of example, risk assessment unit 40 could use the following risk factors and risk values to compute a patient's risk of experiencing contrast induced nephropathy (CIN):

| Risk Factor | Risk Value to Assign |
|---|---|
| systolic blood pressure <80 mm Hg | 5 points |
| using an intraarterial balloon pump | 5 points |
| patient has a congestive heart failure | 5 points |
| (Class III-IV or history of pulmonary edema) | |
| patient is over the age of 75 | 4 points |
| patient has a hematocrit level of less than | 3 points |
| 39% for men or less than 35% for women | |
| Contrast media volume | 1 point per 100 mL |
| | to be delivered |
| patient has a serum creatinine level of | Assign 4 points |
| greater than 1.5 g/dL | |
| patient's estimated glomerular | 2 points for 40-60 |
| filtration rate | mL/min/1.73 m² |
| | 4 points for 20-40 |
| | mL/min/1.73 m² |
| | 6 points for <20 |
| | mL/min/1.73 m² |

The overall risk assessment could then be determined using the following risk scale:

| | Risk of Contrast |
|---|---|
| Total Risk Value | Induced Nephropathy |
| 5 points or less | 7.5% |
| 6-10 points | 14% |
| 11-16 points | 26.1% |
| More than 16 points | 57.3% |

(See R. Mehran, E. D. Aymong, E. Nikolsky, et al., “A simple risk score for prediction of contrast-induced nephropathy after percutaneous coronary intervention,” J Am Coll Cardiol. 2004, 44(7): p. 1393-1399).

Risk assessment unit 40 can be programed with one or more profiles. Each profile may correspond to a particular set of operating instructions, with the different profiles calculating risk assessments based on a different set of criteria. Each profile could represent the preferred set of instructions for a particular user, for a particular facility, or for a particular institution, and may reflect what a certain user/facility/institution considers “best practices” for risk assessment. Risk assessment unit 40 can also be periodically modified and/or updated as additional information, including additional clinical information about risk factors and associated risk scores, becomes known. Further, as explained below, risk assessment unit 40 can be modified based on observed outcome of medical procedures and a comparison of the actual outcome (e.g., whether an adverse reaction occurred) with the predicted outcome (e.g., whether an adverse reaction was predicted) for each procedure. In this sense, the risk assessment unit 40 can include a closed-loop feedback mechanism.

With reference to FIG. 5, once the patient's risk assessment is determined, a risk alert unit 60 can alert the appropriate technologists, radiologists, and/or other personnel of the patient's risk assessment. This can be done in a number of different ways, with the ultimate goal being to ensure that the risks associated with the upcoming procedure are made known before the procedure begins. For instance, the physician or other individual ordering a medical procedure that calls for the delivery of contrast media could be alerted almost immediately upon entering the order of the risk associated with that procedure. This could be done by computing the risk assessment at the risk assessment unit 40 and then electronically communicating through the risk alert unit 60 the result to the CPOE system or other system where the order was placed. In another example, the risk assessment unit 40 could connect with a system used in selecting and/or recommending injection protocols, such as those systems offered in the Certegra® Informatics platform (e.g., Certegra® Workstation (CWS) and the Certegra® P3T® Cardiac, Abdomen and PA applications) by Bayer Healthcare LLC, to provide a risk assessment that is associated with a certain protocol. For example, United States Patent Publication No. 2010/0113887, entitled PATIENT-BASED PARAMETER GENERATION SYSTEMS FOR MEDICAL INJECTION PROCEDURES, filed Dec. 21, 2007, the disclosure of which is incorporated herein by reference, discloses a system that includes a parameter generation system to determine parameters of at least one phase of an injection procedure that could be used in conjunction with the present invention. In this way, a technologist or other medical personnel would know immediately whether a proposed protocol poses an unacceptably high risk of the occurrence of an adverse reaction. In yet another example, the risks in a procedure involving the delivery of contrast media computed by risk assessment unit 40 could be electronically communicated to the injector which will be used to deliver the contrast to alert the technician or radiologist of the risks associated with that injection. This latter example may be particularly useful as it provides time to gather the necessary information to make a more informed risk assessment. Further, the injector interface may be the first opportunity to interface with the technician or radiologist who will be responsible for delivering the contrast to the patient. Any available communication protocol, such as those discussed above, can be used by risk alert unit 60 during the alert process. Alternatively, risk assessment unit 40 and risk alert unit 60 may already reside on the injector, in which case the risk can be easily and immediately conveyed to the technician.

The risk can be reported to the technologists, radiologists, etc. in a variety of different ways, though it is generally preferred that an indication of the risk be represented in a visually perceptible form. By way of example, the patient's overall risk score could be displayed on the interface on the injector. By way of another example, a flashing red light on the injector interface could be used to indicate a particularly high-risk patient. An indication of the risk could also be reported in the work list available through RIS. For example, an indicator, such as a color-coding scheme, could be provided on the RIS work list to indicate which patients on the list face a high risk of experiencing an adverse reaction, as well as what the severity of such reaction might be. Ideally, the risk assessment is automatically propagated to the appropriate destinations once computed, especially in the case where the risk of a reaction and/or severity of the reaction are high. In this sense, system 10 can be configured to include an “auto-alert” feature for automatically informing the appropriate personnel of a patient's risk of suffering an adverse reaction.

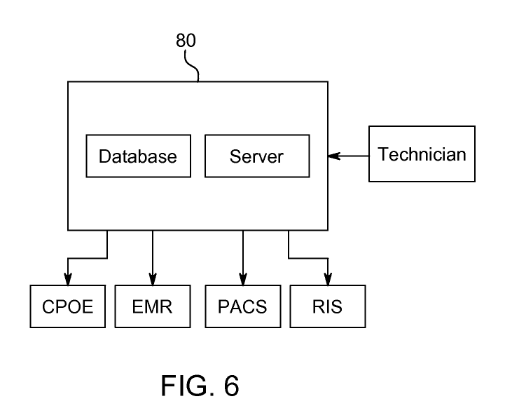

With reference to FIG. 6, system 10 can also include an outcome recording unit 80 for gathering, processing, recording, and storing for future use information about the actual outcome of the procedure, and particularly whether any adverse reaction occurred and the severity of the reaction. Outcome recording unit 80 can include software and hardware that assist with the gathering of information about the outcome of the medical procedure. In one non-limiting embodiment, outcome recording unit 80 includes software located at or near the site of the medical procedure, such as on the injector, which prompts the technician to enter outcome information shortly after the procedure occurs. Outcome recording unit 80 can also include one or more databases that store this information. Outcome recording unit 80 can also be programmed to transfer outcome information to other locations where such information can be recorded and stored.

This information can be provided by the technician, radiologist, or other personnel that observes the patient during or shortly after the procedure occurs. Such information can be entered through any number of data input sources, including the injector, a handheld tablet computer like those discussed above configured with a user interface to collect adverse-event information, or a work station, and then transferred to outcome recording unit 80 either directly or through one or more intermediate locations. It is also possible that output recording unit 80 can be programmed to seek out this information from other locations. For instance, it is possible that outcome recording unit 80 could parse patient records to determine whether a patient suffered from or had been treated for an adverse reaction. The basic goal is to ensure that information regarding whether a patient suffered an adverse reaction, and what the severity of that reaction was, is properly recorded and stored in an accessible form.

Information about whether a patient suffered an adverse reaction, and what type of reaction the patient suffered, can be used by the system 10 going forward to help predict future occurrences of adverse reactions. For example, if a patient suffers an adverse reaction, a report of the incident, including the severity of the reaction and the associated treatment prescribed, can be electronically generated and sent to one or more databases where it can be stored. Information about the reaction could also be appended to other records about the procedure and patient that already reside in these databases. Such databases include, but are not limited to, those associated with the RIS, the EMR system, the CPOE system, and the picture archiving and communication system (PACS). In one particular example, a photograph of an extravasation site can be captured using a tablet computer equipped with a digital camera and transferred as a DICOM image to the PACS server. This information could also be stored in a database associated with outcome recording unit 80 as well. Transfer of the information can be accomplished using common communication protocols, such as those discussed above. In addition to information about the reaction itself, the report can include information about the patient and the medical procedure, including the information that was already collected by data acquisition unit 20 and used by risk assessment unit 40 in analyzing the patient's risk. Details about the adverse reaction, the patient, and the procedure can then be accessed from one or more of the aforementioned databases.

In certain embodiments, system 10 can access the outcome information to help assess the risks involved in future procedures and to alert of risks associated therewith. If, for example, a patient suffered an adverse reaction as a result of a procedure, such as the administration of contrast, and a physician were to order a similar procedure (such as another procedure that involved the administration of contrast media) for that same patient in the future, the system 10 could quickly access the database, retrieve the stored information about the past adverse reactions, and inform the physician of the patient's history of adverse reactions. The physician could also be provided with the details of the procedures that caused such reactions. It is also possible for the physician to simply request a patient's history of adverse reactions even before ordering a procedure. Even if there is no information (or insufficient information) about the specific patient in question, the system 10 may access the database to retrieve historical information about similar patients (e.g., patients of the same age, sex, risk factors, etc.). This may be particularly useful in pediatrics where having a patient-specific history of procedure outcomes is unlikely. By presenting this information to the ordering physician at the time the procedure is being ordered, the physician may elect to modify, or altogether forego, the procedure being ordered, thereby avoiding the scheduling of inappropriate procedures.

Information on whether an adverse reaction occurred can also be used to gauge and improve upon the effectiveness of risk assessment unit 40 by comparing the computed risk assessment to what actually happened during the procedure. Any inconsistencies between the computed risk assessment and the actual result can be used in reconfiguring the risk assessment unit 40, such as by improving the rules by which a risk assessment is computed. For example, if the risk assessment unit 40 computed a “low risk” for a particular patient, and the patient nevertheless suffered an adverse reaction, this risk assessment unit 40 can “learn” from this inconsistency so that the same mistake is not repeated in the future. Information about the actual outcomes becomes particularly useful once a large sample set is available. This information can also be directly used by risk assessment unit 40 because, as mentioned above, one of the known risk factors is whether the patient has a history of suffering adverse reactions. Thus, building a library of information about past results can be helpful in predicting the risks of future procedures.

The above feedback aspect of the invention can be implemented by obtaining a rank score from the operating technologist, nurse, or radiologist about the quality and accuracy of the predictive capability of the system 10. This score could then be used to measure any deviation in accuracy of the prediction. This rank score could be compiled by presenting, upon completion of contrast administration procedure, on the user interface associated with the injector a query asking for the operating technologist to score or rate the quality of the prediction alert system according to a predetermined scale such as Good (2 stars), Ok (1 stars), Poor (no star). If the score is poor, an additional prompt could be presented asking for additional information or reasons for the poor score. The score and the reason(s) supporting the score could then be stored in a database, which would help determine the deviation. Another potential implementation could take advantage of voice-reporting software systems or “VR systems” (like PS-360 from Nuance) used by radiologists while reading a study that can convert voice to text. Typically, VR systems integrate with other hospital systems (like PACS, RIS) through custom-fields, and can serve as a generic place holder to store any kind of information pertaining to the procedure that a radiologists wishes to store. VR vendors typically provide “public API” in order to read/write these custom-fields. These custom-fields could be used to present the computed overall risk score and also store radiologist feedback about the performance of the system 10 made while later reviewing the study. The process of gathering feedback information could be implemented through a series of steps, including: updating the custom fields with the overall risk score and possibly other related clinical data for a patient; completing the contrast study and collecting a record of any adverse reactions entered by the technologist at the point of care; presenting the overall risk score to the radiologist along with the study results; allowing the radiologist to judge the accuracy of the overall risk score; allowing system 10 or another system to “mine” these scores to measure deviations and assess inaccuracies with the risk prediction functionality of system 10.

The following examples are presented to demonstrate the general principles, operation, and advantages of the invention. The invention should not be considered limited to the specific examples presented.

### EXAMPLES

### Example 1

Patient A is scheduled for a contrast imaging procedure. The serum-creatinine reports for Patient A indicate that Patient A has normal serum-creatinine levels. A normal serum-creatinine level would suggest that Patient A is not at risk of suffering a contrast-related adverse reaction. However, system 10 is enabled and data acquisition unit 20 collects various additional pieces of information about Patient A from various information sources 30 within the facility. For example, data acquisition unit 20 acquires from HIS (or another hospital system, such as RIS) information indicating that Patient A has a systolic blood pressure of less than 80 mm Hg, that Patient A suffers from diabetes, that Patient A is over 75 years old, that Patient A suffers from anemia, and that an intra-aortic balloon pump is in use. Risk assessment unit 40 then uses this information to calculate an overall risk score for Patient A based on the collected information by assigning risk values to the different risk factors as follows:

| Risk Factor | Individual Risk Score |
|---|---|
| Systolic blood pressure less than 80 mm Hg | 5 |
| Suffers from diabetes | 3 |
| Age over 75 | 4 |
| Suffers from anemia | 3 |
| With IABP (intra-aortic balloon pump) | 5 |
| Overall Risk Score for Patient A | 20 |

This overall score is then compared to a predetermined risk scale programmed into risk assessment unit 40. In this instance, the risk scale reported by Mehran, et al. mentioned above is used. As a result of this analysis, it is determined that Patient A has over a 57% likelihood of suffering from contrast-induced nephropathy. This risk determination can then be automatically reported by risk alert unit 60 to the technologist by sending a signal to the injector and displaying on the injector interface a visual indication of the risk before contrast media is administered to Patient A. Upon being made aware of this risk, the technologist can take appropriate action, including foregoing administration of the contrast altogether. Absent system 10, the risk of an adverse reaction in Patient A would very likely have escaped the eye of a human technologist or nurse as none of the risk factors, taken individually, immediately suggest Patient A was at a high risk of suffering an adverse reaction.

### Example 2

Patient B is scheduled for a contrast imaging procedure. The serum-creatinine reports for Patient B indicate that Patient B has normal serum-creatinine levels. System 10 is enabled and data acquisition unit 20 collects various additional pieces of information about Patient B from various information sources 30 within the facility. For example, data acquisition unit 20 acquires from HIS (or another hospital system, such as RIS) information indicating that Patient B has normal blood pressure, that Patient B suffers from diabetes, that Patient B is over 75 years old, that Patient B suffers from anemia, that an intra-aortic balloon pump is in use, and that Patient B has a eGFR score of 60. Risk assessment unit 40 then uses this information to calculate an overall risk score for Patient B based on the collected information by assigning risk values to the different risk factors as follows:

| Risk Factor | Individual Risk Score |
|---|---|
| Normal blood pressure | 0 |
| Suffers from diabetes | 3 |
| Age over 75 | 4 |
| Suffers from anemia | 3 |
| With IABP (intra-aortic balloon pump) | 5 |
| eGFR of 60 | 2 |
| Overall Risk Score for Patient B | 17 |

This overall score is then compared to a predetermined risk scale programmed into risk assessment unit 40. In this instance, the risk scale reported by Mehran, et al. mentioned above is used. As a result of this analysis, it is determined that Patient B has over a 57% likelihood of suffering from contrast-induced nephropathy. This risk determination can then be automatically reported by risk alert unit 60 to the technologist by sending a signal to the injector and displaying on the injector interface a visual indication of the risk before contrast media is administered to Patient B. Upon being made aware of this risk, the technologist can take appropriate action, including foregoing administration of the contrast altogether. Absent system 10, the risk of an adverse reaction in Patient B would very likely have escaped the eye of a human technologist or nurse as none of the risk factors, taken individually, immediately suggest Patient B was at a high risk of suffering an adverse reaction.

### Example 3

Patient C is scheduled for a contrast imaging procedure. System 10 is enabled and data acquisition unit 20 collects various pieces of information about Patient C from various information sources 30 within the facility. For example, data acquisition unit 20 acquires from HIS (or another hospital system, such as RIS) information indicating that Patient C has normal blood pressure, that Patient C does not suffer from diabetes, and that Patient C has a normal eGFR score. All of these indications suggest that Patient C is not at risk of suffering an adverse reaction. However, data acquisition unit 20 also collects information indicating that Patient C has a history of adverse reactions from contrast media. Risk assessment unit 40 then uses this information to calculate a total risk score for Patient C based on the collected information by assigning risk values to the different risk factors as follows:

| Risk Factor | Individual Risk Score |
|---|---|
| Mormal blood pressure | 0 |
| Mo diabetes | 0 |
| Normal eGFR | 0 |
| Has history of allergic reactions to contrast | 7 |
| Overall Risk Score for Patient C | 7 |

This overall score is then compared to a predetermined risk scale programmed into risk assessment unit 40. In this instance, the risk scale is derived from Kobayashi, D., et al., “Risk factors for adverse reactions from contrast agents for computed tomography,” BMC Med Inform Decis Mak. 2013; 13: 18. As a result of this analysis, it is determined that, although Patient C appears normal, information about Patient C's history of adverse reaction indicates that Patient C is at a high risk of suffering an adverse reaction if contrast media is administered. This risk can then be automatically reported to the technologist before the contrast is administered. Absent the use of system 10, information about Patient C's history of adverse reactions, and thus the risk of the upcoming administration, may not have been available to the operating technologist.

While the embodiments of systems, devices, and methods described hereinabove may be used to predict and manage contrast-induced adverse reactions, those skilled in the art may make modifications and alterations to these embodiments without departing from the scope and spirit of the invention. Accordingly, the foregoing description is intended to be illustrative rather than restrictive.

What is claimed is:

1. A method, comprising:
acquiring, by a data acquisition unit, information about a patient and information about an upcoming medical procedure for said patient, wherein said medical procedure involves the administration of contrast media to said patient;
computing in advance of said medical imaging procedure, by a risk assessment unit, a prediction of a risk that said patient will experience an adverse reaction to said contrast media based on at least said information about said patient and said information about said upcoming medical procedure acquired by said data acquisition unit; and
presenting to one or more medical personnel in advance of said medical procedure, by a risk alert unit, an indication of said risk in a visually perceptible form.

2. The method of claim 1, wherein said information about said patient comprises one or more of a patient's age, sex, underlying medical conditions, hematologic conditions, medications, and history of adverse reactions to contrast media.

3. The method of claim 1, wherein said computing of said prediction of said risk comprises comparing said information about said patient and said information about said medical procedure to one or more risk factors stored in memory.

4. The method of claim 1, wherein at least a portion of said information about said patient is acquired from a hospital system selected from the group consisting of: a radiology information system, an electronic medical record system, a hospital information system, and a laboratory information system.

5. The method of claim 1, wherein said indication of said risk is displayed on an interface associated with a contrast media injector.

6. The method of claim 1, further comprising preparing a database record comprising said information about said patient, said information about said medical procedure, and said computed risk.

7. The method of claim 6, further comprising storing said database record in a database.

8. The method of claim 1, further comprising acquiring outcome information regarding whether an adverse reaction to said contrast media occurred in said patient as a result of said medical procedure.

9. The method of claim 8, further comprising preparing a database record comprising said information about said patient, said information about said medical procedure, said computed risk, and said outcome information.

10. The method of claim 9, further comprising storing said database record in a database.

11. A system, comprising:
a data acquisition unit programmed to acquire information about a patient and information about an upcoming medical procedure involving the administration of contrast media to said patient;
a risk assessment unit in electronic communication with said data acquisition unit programmed to compute a prediction of a risk of an adverse reaction to said contrast media in said patient based on said information about said patient and said information about said upcoming medical procedure acquired by said data acquisition unit; and
a risk alert unit in electronic communication with said risk assessment unit programmed to present an indication of said risk computed by said risk assessment unit in a visually perceptible form in advance of said medical procedure.

12. The system of claim 11, wherein said data acquisition unit is in electronic communication with a hospital system selected from the group consisting of: a radiology information system, an electronic medical record system, and a laboratory information system.

13. The system of claim 11, wherein said indication of said risk is presented on an injector interface.

14. The system of claim 11, further comprising at least one database to store said information about said patient and said information about said upcoming medical procedure.

15. The system of claim 11, further comprising an outcome recording unit programmed to collect and process outcome information about an outcome of said medical procedure.

16. The system of claim 15, comprising at least one database to store said outcome information.

17. The system of claim 11, further comprising a tablet computer in electronic communication with said data acquisition unit.

18. The system of claim 11, further comprising a tablet computer configured to display said indication of said risk.

19. Software residing on a computer or series of computers, the software comprising programming instructions that, if executed, enable a processor or series of processors to:
acquire information about a patient and information about an upcoming medical imaging procedure for said patient, wherein said medical imaging procedure involves the administration of contrast media to said patient;
compute in advance of said medical imaging procedure a prediction of a risk that said patient will experience an adverse reaction to said contrast media based on at least said information about said patient and said information about said upcoming medical procedure; and
present to one or more medical personnel in advance of said medical imaging procedure an indication of said risk in a visually perceptible form.
